(19) United States
(12) Patent Application Publication
(10) Pub. No.: US 2019/0248110 A1
(43) Pub. Date: Aug. 15, 2019

(54) Laminate Structure, Construct, And Methods Of Using The Same

(71) Applicant: Graphic Packaging International, LLC, Atlanta, GA (US)

(72) Inventors: William Gilpatrick, Broomfield, CO (US); Jeffrey T. Sloat, Broomfield, CO (US); Corey Desmond Crooks, Erie, CO (US)

(21) Appl. No.: 16/007,304

(22) Filed: Jun. 13, 2018

Related U.S. Application Data
(60) Provisional application No. 62/629,279, filed on Feb. 12, 2018.

(51) Int. Cl. B32B 7/12; B32B 29/00; B32B 1/02; B32B 37/12; B65D 81/34

(52) U.S. Cl. CPC B32B 7/12; B32B 29/002; B32B 1/02; B32B 37/12; B65D 81/3453; B65D 2581/3498; B32B 2307/308; B32B 2439/70; B32B 2309/02; B65D 2581/3472; B65D 81/3461

(57) ABSTRACT

A laminate structure includes a base layer, a thermally stable adhesive disposed on at least a portion of the base layer, and a susceptor overlying the base layer and the thermally stable adhesive. The thermally stable adhesive substantially maintains the thermal profile of the susceptor at a temperature of about 250° F. (121° C.) and above.

### CROSS-REFERENCE TO RELATED APPLICATION

This application claims the benefit of U.S. Provisional Patent Application No. 62/629,279, filed on Feb. 12, 2018.

### INCORPORATION BY REFERENCE

The disclosure of U.S. Provisional Patent Application No. 62/629,279, filed on Feb. 12, 2018 is hereby incorporated by reference for all purposes as if presented herein in its entirety.

### BACKGROUND OF THE DISCLOSURE

The present disclosure generally relates to laminate structures for forming constructs for holding one or more food products. More specifically, the present disclosure relates to a laminate structure for forming a construct for holding one or more food products and that includes an adhesive that maintains a thermal profile of the construct in high heat environments.

### SUMMARY OF THE DISCLOSURE

According to one aspect of the disclosure, a laminate structure comprises a base layer, a thermally stable adhesive disposed on at least a portion of the base layer, and a susceptor overlying the base layer and the thermally stable adhesive. The thermally stable adhesive substantially maintains the thermal profile of the susceptor at a temperature of about 250° F. (121° C.) and above.

According to another aspect of the disclosure, a construct for holding at least one food product comprises laminate structure extending at least partially around an interior of the construct. The laminate structure comprises a base layer, a thermally stable adhesive disposed on at least a portion of the base layer, and a susceptor overlying the base layer and the thermally stable adhesive. The thermally stable adhesive substantially maintains the thermal profile of the susceptor at a temperature of about 250° F. (121° C.) and above.

According to another aspect of the disclosure, a method of forming a laminate structure comprises obtaining a base layer, disposing a thermally stable adhesive on at least a portion of the base layer, and applying a susceptor overlying the base layer and the thermally stable adhesive. The thermally stable adhesive is configured to maintain the thermal profile of the susceptor at a temperature of about 250° F. (121° C.) and above.

### BRIEF DESCRIPTION OF THE DRAWINGS

Those skilled in the art will appreciate the above stated advantages and other advantages and benefits of various additional embodiments reading the following detailed description of the embodiments with reference to the below-listed drawing figures.

According to common practice, the various features of the drawings discussed below are not necessarily drawn to scale. Dimensions of various features and elements in the drawings may be expanded or reduced to more clearly illustrate the embodiments of the disclosure.

FIG. 1 is a schematic, perspective parts-separated view of a laminate structure according to an exemplary embodiment of the disclosure.

FIG. 2 is a cross-sectional view of the base layer of the laminate structure of FIG. 1 being coated with adhesive.

FIG. 3 is a cross-sectional view of the susceptor film of FIG. 1 being applied to the base layer and adhesive of FIG. 2.

FIG. 4 is a cross-sectional view of the assembled laminate structure of FIG. 1

FIG. 5 is a perspective view of a construct formed from the laminate structure of FIG. 1 according to an exemplary embodiment of the disclosure.

FIG. 6 is a perspective view of the construct of FIG. 5 being exposed to microwave energy.

FIG. 7 is a cross-sectional view of a portion of the construct of FIG. 6 and having one or more discontinuities formed therethrough.

FIG. 8 is a perspective view of a construct formed from the laminate structure of FIG. 1 according to an exemplary embodiment of the disclosure.

FIG. 9 is a perspective view of the construct of FIG. 5 being exposed to microwave energy.

Corresponding parts are designated by corresponding reference numbers throughout the drawings.

### DETAILED DESCRIPTION OF THE EXEMPLARY EMBODIMENTS

Various aspects of the disclosure may be understood further by referring to the figures. For purposes of simplicity, like numerals may be used to describe like features. It will be understood that where a plurality of similar features are depicted, not all of such features necessarily are labeled on each figure. It also will be understood that the various components used to form the constructs may be interchanged. Thus, while only certain combinations are illustrated herein, numerous other combinations and configurations are contemplated hereby.

Constructs according to the present disclosure can accommodate articles of numerous different shapes. For the purpose of illustration and not for the purpose of limiting the scope of the disclosure, the following detailed description describes articles such as food products at least partially disposed within the construct embodiments. In this specification, the terms “lower,” “bottom,” “upper”, “top”, “front”, and “back” indicate orientations determined in relation to fully erected constructs.

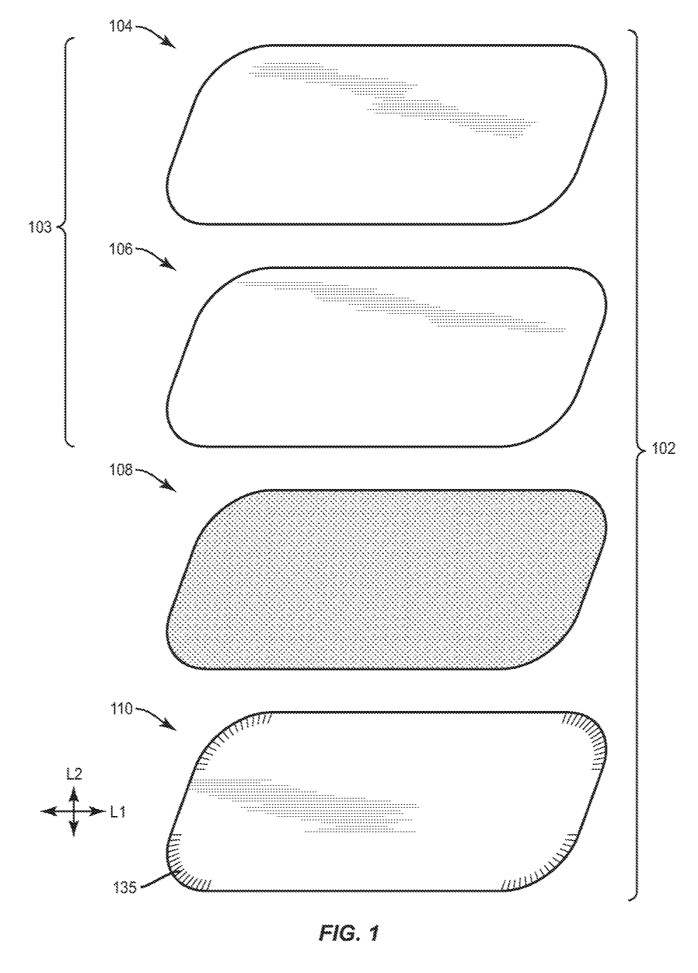

Referring to FIG. 1, a blank or laminate structure 102 for forming a construct 100 (FIG. 5) is illustrated according to an exemplary embodiment of the disclosure. The construct 100 can be used to hold one or more food products, and can include one or more microwave energy interactive materials (MEIMs) so that the construct 100 can generate heat upon exposure to microwave energy, for example, in a microwave oven. As described herein, the laminate structure 102 and the construct 100 formed therefrom are provided with an adhesive 108 configured to maintain a thermal profile, e.g., the property of generating heat at a predetermined profile in the presence of microwave energy, in high heat environments, e.g., high temperature environments, for example, temperatures of the laminate structure 102 at or above about 250° F. (121° C.).

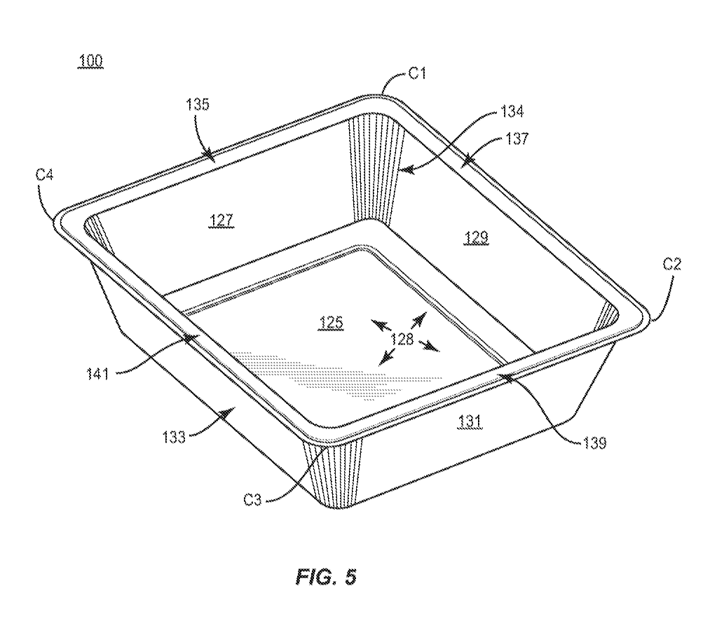

As shown, the laminate structure 102 includes a susceptor film 103 that includes a food-contacting or surface film 104 and a conductive material or susceptor 106, an adhesive 108, and a base layer of material 110. In this regard, the food-contacting film 104 forms an interior or food-supporting surface of the laminate structure 102. The food-contacting film 104 can be formed of, for example, a polymeric material 105 (FIG. 4). In one embodiment, the polymeric material 105 can be polyester. The food-contacting film 104 can provide barrier properties for at least the base layer 110, for example, resistance to the passage of fluids such as moisture, oil, and/or food runoff The food-contacting film 104 can be formed of additional or alternative materials, for example, metallic or composite materials, without departing from the disclosure.

In one embodiment, the food-contacting film 104 and the susceptor 106 can be separately-formed elements that are coupled to provide the susceptor film 103. In another embodiment, the food-contacting film 104 can be provided with a conductive material such as a metallic material, for example, aluminum. In this regard, the food-contacting film 104 can be metallized to provide the susceptor film 103. In still another embodiment, the susceptor 106 can be provided with a coating or surface treatment that performs similarly to the food-contacting film 104 to provide the susceptor film 103. In yet another embodiment, the susceptor 106 can be provided without an accompanying film or film-like treatment.

The base layer 110 can be a paper or paper-based product (e.g., paperboard, cardboard, etc.) and has a longitudinal axis L1 extending along a length of the base layer 110, and a lateral axis L2 extending along a width of the base layer 110. The base layer 110, as described herein, supports the adhesive 108 and the susceptor film 103 of the laminate structure 102, and is generally configured to be the same size, shape, and/or dimensions as one or more of those components, through the base layer 110 can be differently-configured without departing from the disclosure.

Still referring to FIG. 1, the laminate structure 102 includes the adhesive 108 disposed between the base layer 110 and the susceptor 106 of the susceptor film 103. The adhesive 108, as described herein, promotes a secure coupling of the susceptor film 103/susceptor 106 and the base layer 110, and the adhesive 108 is configured to substantially maintain its integrity and dimensional and/or positional properties upon exposure to heat. As described herein, the integrity of the adhesive 108 can refer to material properties such as strength (e.g., tensile strength, shear strength, bond strength, etc.), rigidity, and/or viscosity, dimensional properties of the adhesive 108 can refer to a shape, length, width, and/or thickness of the adhesive 108, and positional properties of the adhesive 108 can refer to a position of the adhesive 108 relative to the base layer 110 and/or the susceptor film 103/susceptor 106. In this regard, and as described further herein, the adhesive 108 is configured to maintain a condition of the susceptor film 103/susceptor 106 in high heat/high temperature applications. In the illustrated embodiment, the adhesive 108 is formed of a polymeric material 109 (FIG. 4), for example, a crosslinked polymeric adhesive. In this regard, polymeric material 109 of the adhesive 108 can have a crosslinking agent, e.g., an additive that promotes bonding among polymer chains. The crosslinking agent can be present in an amount to provide crosslinking of the adhesive 106 up to about 5% by weight of the adhesive 106, for example, 0.25%, 0.5%, 0.75%, 1.0%, 1.25%, 1.5%, 1.75%, 2.0%, 2.25%, 2.5%, 2.75%, 3.0%, 3.25%, 3.5%, 3.75%, 4.0%, 4.25%, 4.5%, 4.75%, 5.0%, and non-integer numbers therebetween. In one embodiment, the adhesive 108 includes a crosslinking agent in an amount of about 2.5% by weight of the adhesive 108. In one embodiment, the adhesive 106 can be formed of a crosslinked polymeric adhesive having a Zinc-based crosslinking system, for example, product number 20915 available from Royal Adhesives and Sealants of South Bend, Ind. Such an adhesive 108 can have a viscosity of about 300 cP and a composition of about 57% solids and a crosslinking agent in an amount of about 2.5% by weight of the adhesive 108. A different type and/or material of adhesive with the aforementioned properties can be used without departing from the disclosure.

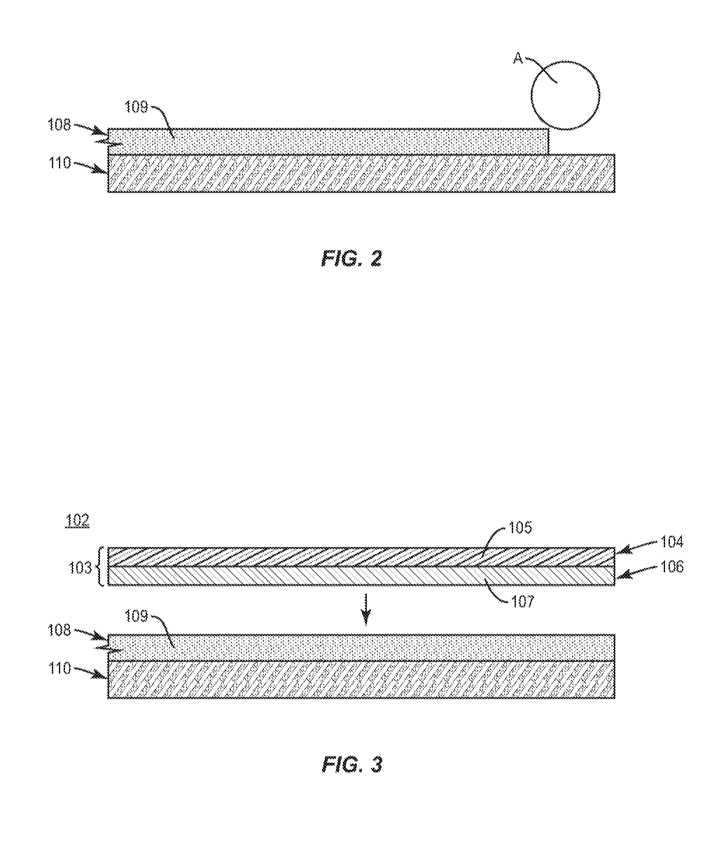

Referring additionally to FIG. 2, in one exemplary embodiment, formation of the construct 100 (FIG. 5) can include coating of the adhesive 108 onto the surface of the base layer 110, for example, with an applicator A, for example, a flexographic apparatus, a gravure roller, or a different type of applicator. The adhesive 108 can be deposited such that the adhesive 108 covers the entire surface of the base layer 110. In other embodiments, the adhesive 108 can be deposited on less than the entire surface of the base layer 110. During deposition of the adhesive 108 on the base layer 110, the base layer 110 can move relative to the path of application of adhesive 108, for example, with a conveyor and/or movable applicator. The adhesive 108 can be applied to the base layer 110 by other methods without departing from the disclosure. In one embodiment, the laminate structure 102 can be assembled prior to cutting, shaping, or otherwise configuring the base layer 110, e.g., such that the base layer 110 is provided as a sheet that is subsequently formed into a desired configuration.

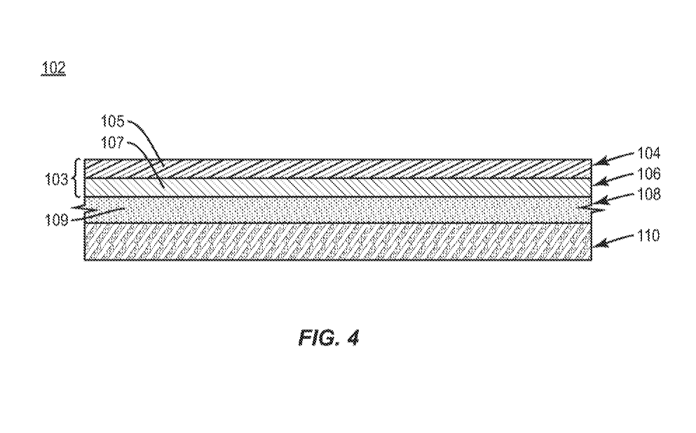

With reference to FIGS. 3 and 4, the susceptor film 103 is applied overlying the base layer 110 having been coated with the adhesive 108 such that the laminate structure 102 including the base layer 110, the adhesive 108, and the susceptor film 103 (including the susceptor 106 and the food-contacting film 104) is formed. In one embodiment, the susceptor film 103 can be provided as a pre-formed layer of material. In another embodiment, the susceptor 106 can be applied to the adhesive 108, for example, through chemical deposition or sputtering, at a thickness at or below the skin depth of the material of the susceptor 106 for a particular microwave application, e.g. a thickness of the susceptor 106 above which current density begins to significantly decrease. The susceptor film 103, as shown, can be applied in a parallel planar arrangement with the base layer 110 following deposition of the adhesive 108 as described herein. In embodiments, the susceptor film 103 can be applied in cooperation with deposition of the adhesive 108, for example, through the use of a roller and nip. In another embodiment, the adhesive 108 can be applied to the susceptor film 103 and the adhesive 108 and the susceptor film 103 can be applied to the base layer 110. The susceptor film 103 can be applied to the base layer 110 in any other suitable manner without departing from the disclosure. The susceptor 106, as shown and described, may be at least partially formed of a microwave energy interactive material 107 that is electrically conductive or semiconductive, for example, a metal or a metal alloy. In the exemplary embodiment shown, the conductive material 107 can be aluminum. The susceptor film 103/susceptor 106 can be patterned or configured, for example, to include one or more discontinuities and/or deactivated regions to provide a desired profile for microwave energy interaction, without departing from the disclosure.

Referring additionally to FIG. 5, the construct 100 formed from the laminate structure 102 is illustrated. The laminate structure 102 can be formed, for example, in a forming tool such as a press (not shown) to form the construct 100. As shown, the construct 100 includes a bottom 125, sidewalls 127, 129, 131, 133 extending upwardly from the bottom 125, and flanges 135, 137, 139, 141 extending outwardly from the respective sidewalls 127, 129, 131, 133. At least the bottom 125 and the sidewalls 127, 129, 131, 133 extend at least partially around an interior 128 of the construct 100. As shown, the laminate structure 102 can be press-formed such that portions of the base layer 110 (and corresponding portions of the adhesive 108 and the susceptor film 103) are overlapped to form pleats 134. Such portions of the base layer 110 and/or corresponding portions of the adhesive 108 and the susceptor film 103 can be provided for example, with one or more score lines 135 (FIG. 1). As also shown, the sidewall 127 and flange 135 intersect the respective sidewall 129 and the flange 137 at a corner C1, the sidewall 129 and the flange 137 intersect the respective sidewall 131 and the flange 139 at a corner C2, the sidewall 131 and the flange 139 intersect the respective sidewall 133 and the flange 141 at a corner C3, and the sidewall 133 and the flange 141 intersect the respective sidewall 127 and the flange 135 at a corner C4.

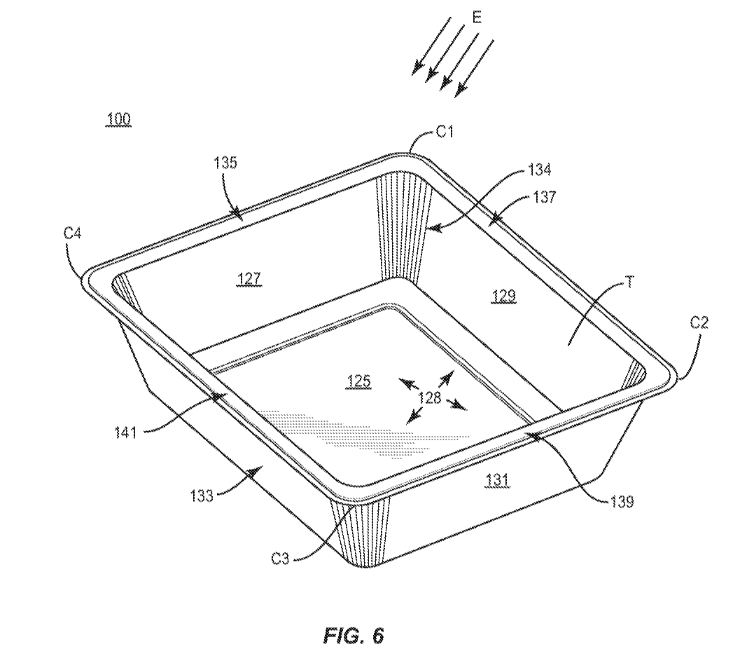

Referring to FIGS. 5 and 6, in use, the construct 100 can be exposed to microwave energy E, for example, electromagnetic radiation generally having a wavelength from 1 m to 1 mm and a frequency between 300 MHz and 300 GHz. Electromagnetic radiation having different properties can be provided without departing from the disclosure. Such microwave energy E can be generated, for example, by a microwave oven. In one embodiment, a microwave oven having a power output of 1100 W can provide the microwave energy E. Microwave energy E impinging upon the construct 100 can cause the susceptor film 103/susceptor 106 to at least partially absorb the microwave energy E, convert at least a portion of the microwave energy E to heat, and thereby cause an increase in temperature in one or more portions of the construct 100, for example, an interior surface of the construct 100. Accordingly, one or more portions of the construct 100, for example, the susceptor film 103/susceptor 106, can be withstand high heat/high temperature applications, for example, to reach a surface temperature T at or above about 250° F. (121° C.), e.g., a temperature between and including about 250° F. (121° C.) and about 350° F. (177° C.), such as 250° F. (121° C.), 255° F. (124° C.), 260° F. (127° C.), 265° F. (129° C.), 270° F. (132° C.), 275° F. (135° C.), 280° F. (138° C.), 285° F. (141° C.), 290° F. (143° C.), 295° F. (146° C.), 300° F. (149° C.), 305° F. (152° C.), 310° F. (154° C.), 315° F. (157° C.), 320° F. (160° C.), 325° F. (163° C.), 330° F. (166° C.), 335° F. (168° C.), 340° F. (171° C.), 345° F. (174° C.), 350° F. (177° C.), or temperatures therebetween, to name a few. In one embodiment, the construct 100 can be exposed to temperatures greater than about 350° F. (177° C.) or less than about 250° F. (121° C.). The adhesive 108 is thermally stable such that, upon exposure of the construct 100 to the microwave energy E and achieving a temperature T at or above about 250° F. (121° C.), the adhesive 108 maintains a condition of the susceptor film 103/susceptor 106, for example, a thermal integrity or thermal profile of the susceptor film 103/susceptor 106 such that the susceptor film 103/susceptor 106 generates heat at a predetermined profile in the presence of microwave energy E to maintain the temperature T. In this regard, the adhesive 108 may maintain a thermal and/or electrical conductivity of one or more portions of the susceptor film 103/susceptor 106, as described further herein.

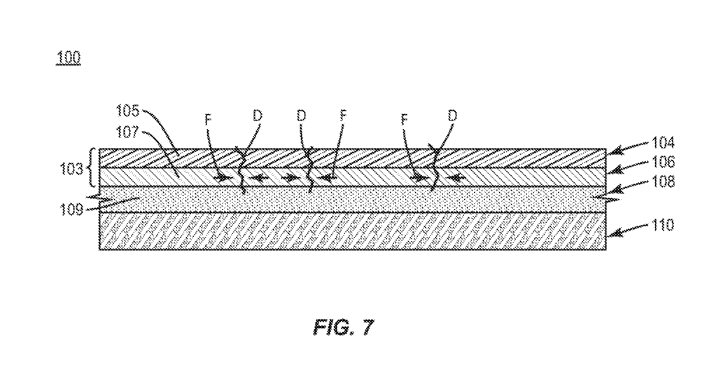

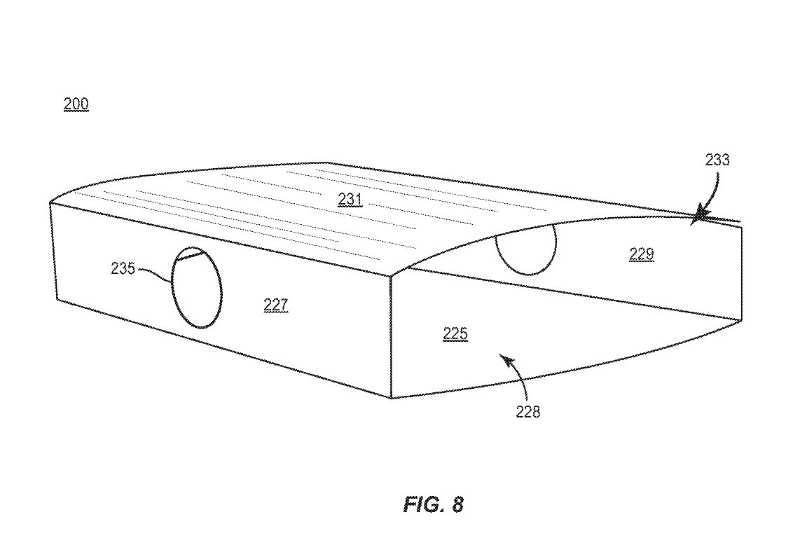

Referring additionally to FIG. 7, a section of the construct 100 is shown in perspective, cross-sectional view. In one embodiment, during use, one or more discontinuities D may be formed in the susceptor film 103/susceptor 106, for example, due to relative motion of the construct 100, due to weakening, e.g., degradation or at least partial disintegration, of one or more portions of the laminate structure 102, and/or due to thermal stresses (for example, at least partially driven by thermal expansion of portions of the susceptor film 103/susceptor 106). Such discontinuities D may be present at the surface of the susceptor 106, and/or may extend at least partially through the thickness of the susceptor 106. The development of one or more discontinuities D may be generally referred to as an effect of crazing of the susceptor 106. As illustrated, the thermally stable configuration of the adhesive 108 is such that the adhesive 108 underlying the susceptor 106 provides one or more binding forces F that resists, inhibits, and/or prevents expansion and/or propagation of the one or more surface discontinuities D such that one or more properties of the susceptor 106, for example, thermal and/or electrical conductivity, is substantially not disrupted (e.g., self-limited) by the formation and presence of the one or more discontinuities D. In this regard, the adhesive 108 can maintain in at least partial contact with portions of the susceptor film 103/susceptor 106 adjacent a respective discontinuity D, for example, such that a capacity of the susceptor film 103/susceptor 106 for thermal and/or electrical conduction in such regions is substantially maintained and not disrupted. In addition, the adhesive 108 substantially maintains its integrity and dimensional and/or positional properties, for example, such that the susceptor film 103/susceptor 106 maintains a fixed position over the base layer 110. Further, the adhesive 108 substantially maintains its integrity and dimensional and/or positional properties in the presence of microwave energy E and any resulting high heat/high temperature environment such that the adhesive 108 resists melting or other deformation such that the susceptor 106 remains firmly attached to the base layer 110 and substantially does not slidably move along the adhesive 108. In this regard, the interface between the susceptor film 103/susceptor 106, the adhesive 108, and the base layer 110 is substantially not disrupted in the presence of microwave energy E and any resulting high heat/high temperature environment such that delamination of the laminate structure 102, e.g., separation of the susceptor 106, the adhesive 108, and the base layer 110, is substantially inhibited, minimized, and/or prevented. It will be understood that the construct 100 may be exposed to temperatures less than about 250° F. (121° C.) or greater than about 350° F. (177° C.) and the adhesive 108 will maintain its integrity and dimensional and/or properties as described above. It will also be understood that the construct 100 may be exposed to high heat/high temperature environments as a result of heating other than through exposure to microwave energy, for example, through convection heating, and the adhesive 108 will maintain its integrity and dimensional and/or properties as described above.

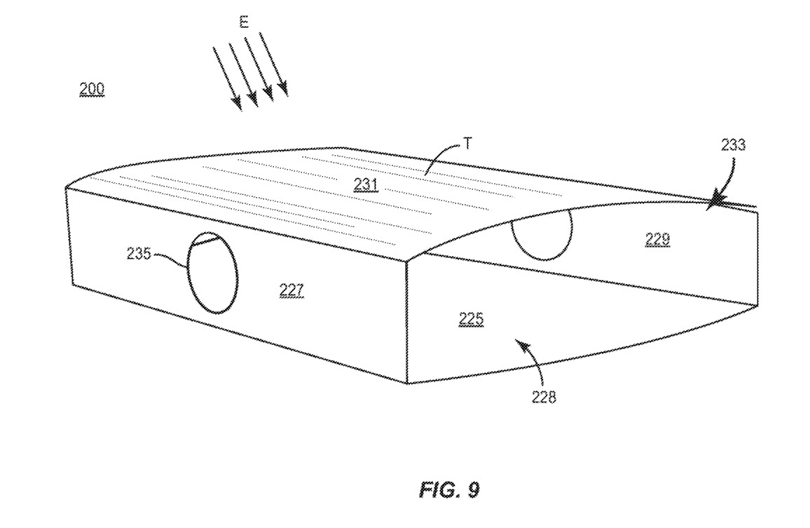

Turning to FIG. 8, a construct 200 formed from the laminate structure 102 is illustrated according to another exemplary embodiment of the disclosure. The construct 200 can be formed, for example, from a blank comprising the laminate structure 102 and which can include one or more lines of weakening to facilitate formation of such blank into the construct 200. As illustrated, the construct 200 can have an open sleeve-like configuration that extends around an interior 228 for at least partially receiving a food product, such as a frozen or nonfrozen breaded item. The illustrated construct 200 includes a base panel 225, a first side panel 227 and a second side panel 229 each foldably connected to and extending upwardly from the base panel 225, a first top panel 231 foldably connected to the first side panel 227, and a second top panel 233 foldably connected to the second side panel 229. The first top panel 231, as shown, is overlapped and in at least partial face-to-face contact with the second top panel 233. One or more venting apertures 235 can be formed in one or more of the panels 225, 227, 229, 231, 233, for example, to facilitate fluid communication between the interior 228 of the construct 200 and an exterior environment. The construct 200 can have a different configuration without departing from the disclosure.

Referring additionally to FIG. 9, the construct 200 can be exposed to microwave energy E such that the susceptor film 103/susceptor 106 (FIG. 4) at least partially absorbs the microwave energy E, convert at least a portion of the microwave energy E to heat, and thereby increase in temperature. The construct 200 is configured so as to withstand high heat/high temperature applications, for example, to reach a surface temperature T at or above about 250° F. (121° C.) as described above with regard to the construct 100. In one embodiment, the construct 200 can be exposed to temperatures greater than about 350° F. (177° C.) or less than about 250° F. (121° C.). As described above, the adhesive 108 is thermally stable such that, upon exposure of the construct 200 to the microwave energy E and achieving a temperature T at or above about 250° F. (121° C.), the adhesive 108 maintains a condition of the susceptor film 103/susceptor 106, for example, a thermal integrity or thermal profile of the susceptor film 103/susceptor 106 such that the susceptor film 103/susceptor 106 generates heat at a predetermined profile in the presence of microwave energy E to maintain the temperature T. In this regard, the adhesive 108 maintains in at least partial contact one or more portions of the susceptor film 103/susceptor 106 adjacent one or more discontinuities D (illustrated with respect to construct 100 in FIG. 7) that may form in the construct 200, e.g., due to crazing, such that a thermal and/or electrical conductivity of one or more portions of the construct 200 are maintained, as described herein.

In general, the blanks or base layers described herein may be constructed from paperboard having a caliper so that it is heavier and more rigid than ordinary paper. The base layer can also be constructed of other materials, such as cardboard, or any other material having properties suitable for enabling the construct to function at least generally as described above. The base layer can be coated with, for example, a clay coating. The clay coating may then be printed over with product, advertising, and other information or images. The base layers may then be coated with a varnish to protect information printed on the base layers. The base layers may also be coated with, for example, a moisture barrier layer, on either or both sides of the base layers. The base layers can also be laminated to or coated with one or more sheet-like materials at selected panels or panel sections.

As described herein, susceptors may be formed from a microwave energy interactive material that is electroconductive or semiconductive, for example, a metal or a metal alloy provided as a metal foil, a vacuum deposited metal or metal alloy, a metallic ink, an organic ink, an inorganic ink, a metallic paste, an organic paste, an inorganic paste, or any combination thereof. Examples of metals and metal alloys that may be suitable include, but are not limited to, aluminum, chromium, copper, inconel alloys (nickel-chromium-molybdenum alloy with niobium), iron, magnesium, nickel, stainless steel, tin, titanium, tungsten, and any combination or alloy thereof. In embodiments, susceptors may be formed from one or more of a metal oxide, a dielectric, a ferroelectric, or may be carbon-based. In embodiments, susceptors may be selected from a material that is generally at least several angstroms thick and less than about 100 angstroms in thickness, for example, from about 50 to about 100 angstroms in thickness, and having an optical density from about 0.15 to about 0.35, for example, about 0.21 to about 0.28.

It will be apparent that numerous other sequences of steps may be used to form constructs as described herein. It also will be apparent that numerous other microwave energy interactive insulating materials or structures may be used to form a construct in accordance with the disclosure. Any of such materials may be used alone or in combination, and in any configuration, to form the construct. Where multiple materials (or multiple layers of the same material) are used, the materials may be joined to one another partially or completely, or may remain separate from one another (i.e., unjoined).

Countless other microwave energy interactive structures and constructs are contemplated by the disclosure. If desired, any of such structures may include one or more areas that are transparent to microwave energy. Such microwave energy transparent areas transmit microwave energy and, in some instances, may cause the formation of localized electric fields that enhance heating, browning, and/or crisping of an adjacent food product or other item. The transparent areas may be sized, positioned, and/or arranged to customize the heating, browning, and/or crisping of a particular area of the food product or other item to be heated.

Any of such structures or constructs may be formed from various materials, provided that the materials are substantially resistant to softening, scorching, combusting, or degrading at typical microwave oven heating temperatures, for example, at from about 250° F. to about 425° F. The materials may include microwave energy interactive materials, for example, those used to form susceptors and other microwave energy interactive elements, and microwave energy transparent or inactive materials, for example, those used to form the remainder of the construct.

Alternatively still, the microwave energy interactive material may comprise a suitable electroconductive, semiconductive, or non-conductive artificial dielectric or ferroelectric. Artificial dielectrics comprise conductive, subdivided material in a polymeric or other suitable matrix or binder, and may include flakes of an electroconductive metal, for example, aluminum.

While susceptors are illustrated herein, the construct also may include a foil or high optical density evaporated material having a thickness sufficient to reflect a substantial portion of impinging microwave energy. Such elements are typically formed from a conductive, reflective metal or metal alloy, for example, aluminum, copper, or stainless steel, in the form of a solid “patch” generally having a thickness of from about 0.000285 inches to about 0.05 inches, for example, from about 0.0003 inches to about 0.03 inches. Other such elements may have a thickness of from about 0.00035 inches to about 0.020 inches, for example, 0.016 inches.

Larger microwave energy reflecting elements may be used where a food product or other item is prone to scorching or drying out during heating and therefore, may be referred to as shielding elements. Smaller microwave energy reflecting elements may be used to diffuse or lessen the intensity of microwave energy. A plurality of smaller microwave energy reflecting elements also may be arranged to form a microwave energy directing element to direct microwave energy to specific areas of the food item. If desired, the loops may be of a length that causes microwave energy to resonate, thereby enhancing the distribution effect. Microwave energy distributing elements are described in U.S. Pat. Nos. 6,204,492, 6,433,322, 6,552,315, and 6,677,563, each of which is incorporated by reference in its entirety.

If desired, any of the numerous microwave energy interactive elements described herein or contemplated hereby may be substantially continuous, that is, without substantial breaks or interruptions, or may be discontinuous, for example, by including one or more breaks or apertures that transmit microwave energy therethrough. The breaks or apertures may be sized and positioned to heat particular areas of a food product or other item selectively. The breaks or apertures may extend through the entire structure, or only through one or more layers. The number, shape, size, and positioning of such breaks or apertures may vary for a particular application depending on the type of construct being formed, the food product or other item to be heated therein or thereon, the desired degree of shielding, browning, and/or crisping, whether direct exposure to microwave energy is needed or desired to attain uniform heating of the food item, the need for regulating the change in temperature of the food item through direct heating, and whether and to what extent there is a need for venting.

It will be understood that an aperture may be a physical aperture or void in one or more layers or materials used to form the construct, or may be a non-physical “aperture” (not shown). A non-physical aperture is a microwave energy transparent area that allows microwave energy to pass through the structure without an actual void or hole cut through the structure. Such areas may be formed by simply not applying microwave energy interactive material to the particular area, or by removing microwave energy interactive material in the particular area, or by mechanically deactivating the particular area (rendering the area electrically discontinuous). Alternatively, the areas may be formed by chemically deactivating the microwave energy interactive material in the particular area, thereby transforming the microwave energy interactive material in the area into a substance that is transparent to microwave energy (i.e., microwave energy inactive). While both physical and non-physical apertures allow the food item to be heated directly by the microwave energy, a physical aperture also provides a venting function to allow steam or other vapors to escape from the interior of the construct.

The arrangement of microwave energy interactive and microwave energy transparent areas may be selected to provide various levels of heating, as needed or desired for a particular application. For example, where greater heating is desired, the total inactive (i.e., microwave energy transparent) area may be increased. In doing so, more microwave energy is transmitted to the food product or other item. Alternatively, by decreasing the total inactive area, more microwave energy is absorbed by the microwave energy interactive areas, converted into thermal energy, and transmitted to the surface of the food product or other item to enhance heating, browning, and/or crisping.

In some instances, it may be beneficial to create one or more discontinuities or inactive regions to prevent overheating or charring of the construct. Such areas may be formed by forming these areas of the construct without a microwave energy interactive material, by removing any microwave energy interactive material that has been applied, or by deactivating the microwave energy interactive material in these areas, as discussed above.

Further still, one or more panels, portions of panels, or portions of the construct may be designed to be microwave energy inactive to ensure that the microwave energy is focused efficiently on the areas to be heated, browned, and/or crisped, rather than being lost to portions of the food product or other item not intended to be browned and/or crisped or to the heating environment. This may be achieved using any suitable technique, such as those described above.

The microwave energy interactive material may be applied to the substrate in any suitable manner, and in some instances, the microwave energy interactive material is printed on, extruded onto, sputtered onto, evaporated on, or laminated to the substrate. The microwave energy interactive material may be applied to the substrate in any pattern, and using any technique, to achieve the desired heating effect of the food item. For example, the microwave energy interactive material may be provided as a continuous or discontinuous layer or coating including circles, loops, hexagons, islands, squares, rectangles, octagons, and so forth.

The susceptor structures and adhesives disclosed herein may be formed according to numerous processes known to those in the art, including using adhesive bonding, thermal bonding, ultrasonic bonding, mechanical stitching, or any other suitable process. Any of the various components used to form the package may be provided as a sheet of material, a roll of material, or a die cut material in the shape of a construct to be formed (e.g., a blank or base layer).

It will be understood that with some combinations of elements and materials, the microwave energy interactive element may have a grey or silver color that is visually distinguishable from a support. However, in some instances, it may be desirable to provide a construct having a uniform color and/or appearance. Such a construct may be more aesthetically pleasing to a consumer, particularly when the consumer is accustomed to constructs having certain visual attributes, for example, a solid color, a particular pattern, and so on. Thus, for example, the present disclosure contemplates using a silver or grey toned adhesive to join the microwave energy interactive element to a support, using a silver or grey toned support to mask the presence of the silver or grey toned microwave energy interactive element, using a dark toned substrate, for example, a black toned substrate, to conceal the presence of the silver or grey toned microwave energy interactive element, overprinting the metallized side of a carrier layer with a silver or grey toned ink to obscure the color variation, printing a non-metallized side of the carrier layer with a silver or grey ink or other concealing color in a suitable pattern or as a solid color layer to mask or conceal the presence of the microwave energy interactive element, or any other suitable technique or combination of techniques.

All directional references (e.g., upper, lower, upward, downward, left, right, leftward, rightward, top, bottom, above, below, vertical, horizontal, clockwise, and counterclockwise) are used only for identification purposes to aid the reader's understanding of the various embodiments of the present disclosure, and do not create limitations, particularly as to the position, orientation, or use of the disclosed embodiments unless specifically set forth in the claims. Joinder references (e.g., joined, attached, coupled, connected, and the like) are to be construed broadly and may include intermediate members between a connection of elements and relative movement between elements. As such, joinder references do not necessarily imply that two elements are connected directly and in fixed relation to each other. Further, various elements discussed with reference to the various embodiments may be interchanged to create entirely new embodiments coming within the scope of the present disclosure.

The foregoing description of the disclosure illustrates and describes various embodiments. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, alterations, etc., of the above-described embodiments. Additionally, the disclosure shows and describes only selected embodiments, but various other combinations, modifications, and environments are within the scope of the disclosure as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

The foregoing description illustrates and describes various embodiments of the disclosure. As various changes could be made in the above construction, it is intended that all matter contained in the above description or shown in the accompanying drawings shall be interpreted as illustrative and not in a limiting sense. Furthermore, various modifications, combinations, and alterations, etc., of the above-described embodiments are within the scope of the disclosure. Additionally, the disclosure shows and describes only selected embodiments, but various other combinations, modifications, and environments are within the scope of the disclosure, commensurate with the above teachings, and/or within the skill or knowledge of the relevant art. Furthermore, certain features and characteristics of each embodiment may be selectively interchanged and applied to other illustrated and non-illustrated embodiments without departing from the scope of the disclosure.

What is claimed is:

1. A laminate structure, comprising:
a base layer;
a thermally stable adhesive disposed on at least a portion of the base layer; and
a susceptor overlying the base layer and the thermally stable adhesive, the thermally stable adhesive substantially maintains the thermal profile of the susceptor at a temperature of about 250° F. (121° C.) and above.

2. The laminate structure of claim 1, wherein the thermally stable adhesive substantially maintains the thermal profile of the susceptor at a temperature between about 250° F. (121° C.) and about 350° F. (177° C.).

3. The laminate structure of claim 1, wherein the thermally stable adhesive is comprised of a crosslinked polymeric material.

4. The laminate structure of claim 3, wherein the thermally stable adhesive comprises a crosslinking agent in an amount between about 0.25% and about 5.0% by weight of the thermally stable adhesive.

5. The laminate structure of claim 4, wherein the thermally stable adhesive comprises a crosslinking agent in an amount of about 2.5% by weight of the thermally stable adhesive.

6. The laminate structure of claim 1, wherein the laminate structure comprises a susceptor film, the susceptor film comprising a food-contacting film and the susceptor.

7. The laminate structure of claim 6, wherein the food-contacting film is comprised of a polymeric material.

8. The laminate structure of claim 7, wherein the thermally stable adhesive is comprised of a crosslinked polymeric material having a crosslinking agent in an amount between about 0.25% and about 5.0% by weight of the thermally stable adhesive.

9. The laminate structure of claim 8, wherein the base layer is comprised of paperboard.

10. The laminate structure of claim 1, wherein the thermally stable adhesive substantially maintains the electrical conductivity of the susceptor at a temperature of about 250° F. (121° C.) and above.

11. The laminate structure of claim 1, wherein the thermally stable adhesive substantially maintains the thermal conductivity of the susceptor at a temperature of about 250° F. (121° C.) and above.

12. The laminate structure of claim 1, wherein the thermally stable adhesive substantially maintains portions of the susceptor adjacent one or more discontinuities extending through the susceptor in at least partial contact at a temperature of about 250° F. (121° C.) and above.

13. The laminate structure of claim 12, wherein the thermally stable adhesive provides a binding force to portions of the susceptor adjacent the one or more discontinuities.

14. A construct for holding at least one food product, comprising:
a laminate structure extending at least partially around an interior of the construct, the laminate structure comprising:
a base layer;
a thermally stable adhesive disposed on at least a portion of the base layer; and
a susceptor overlying the base layer and the thermally stable adhesive, the thermally stable adhesive substantially maintains the thermal profile of the susceptor at a temperature of about 250° F. (121° C.) and above.

15. The construct of claim 14, wherein the thermally stable adhesive substantially maintains the thermal profile of the susceptor at a temperature between about 250° F. (121° C.) and about 350° F. (177° C.).

16. The construct of claim 14, wherein the thermally stable adhesive is comprised of a crosslinked polymeric material.

17. The construct of claim 16, wherein the thermally stable adhesive comprises a crosslinking agent in an amount between about 0.25% and about 5.0% by weight of the thermally stable adhesive.

18. The construct of claim 17, wherein the thermally stable adhesive comprises a crosslinking agent in an amount of about 2.5% by weight of the thermally stable adhesive.

19. The construct of claim 17, wherein the laminate structure is press-formed such that the construct comprises a bottom and at least one sidewall extending upwardly from the sidewall and extending at least partially around the interior of the construct.

20. The construct of claim 17, wherein the construct has the configuration of an open sleeve.

21. The construct of claim 14, wherein the laminate structure comprises a susceptor film, the susceptor film comprising a food-contacting film and the susceptor.

22. The construct of claim 21, wherein the food-contacting film is comprised of a polymeric material.

23. The construct of claim 22, wherein the thermally stable adhesive is comprised of a crosslinked polymeric material having a crosslinking agent in an amount between about 0.25% and about 5.0% by weight of the thermally stable adhesive.

24. The construct of claim 23, wherein the base layer is comprised of paperboard.

25. The construct of claim 14, wherein the thermally stable adhesive substantially maintains the electrical conductivity of the susceptor at a temperature of about 250° F. (121° C.) and above.

26. The construct of claim 14, wherein the thermally stable adhesive substantially maintains the thermal conductivity of the susceptor at a temperature of about 250° F. (121° C.) and above.

27. The construct of claim 14, wherein the thermally stable adhesive substantially maintains portions of the susceptor adjacent one or more discontinuities extending through the susceptor in at least partial contact at a temperature of about 250° F. (121° C.) and above.

28. The construct of claim 27, wherein the thermally stable adhesive provides a binding force to portions of the susceptor adjacent the one or more discontinuities.

29. A method of forming a laminate structure, the method comprising:
obtaining a base layer;
disposing a thermally stable adhesive on at least a portion of the base layer; and
applying a susceptor overlying the base layer and the thermally stable adhesive, the thermally stable adhesive is configured to maintain the thermal profile of the susceptor at a temperature of about 250° F. (121° C.) and above.

30. The method of claim 29, wherein the thermally stable adhesive substantially maintains the thermal profile of the susceptor at a temperature between about 250° F. (121° C.) and about 350° F. (177° C.).

31. The method of claim 29, wherein the thermally stable adhesive is comprised of a crosslinked polymeric material.

32. The method of claim 31, wherein the thermally stable adhesive comprises a crosslinking agent in an amount between about 0.25% and about 5.0% by weight of the thermally stable adhesive.

33. The method of claim 32, wherein the thermally stable adhesive comprises a crosslinking agent in an amount of about 2.5% by weight of the thermally stable adhesive.

34. The method of claim 29, wherein the susceptor is part of a susceptor film, the susceptor film comprising a food-contacting film and the susceptor.

35. The method of claim 34, wherein the food-contacting film is comprised of a polymeric material.

36. The method of claim 35, wherein the thermally stable adhesive is comprised of a crosslinked polymeric material having a crosslinking agent in an amount between about 0.25% and about 5.0% by weight of the thermally stable adhesive.

37. The method of claim 36, wherein the base layer is comprised of paperboard.

38. The method of claim 29, wherein the thermally stable adhesive substantially maintains the electrical conductivity of the susceptor at a temperature of about 250° F. (121° C.) and above.

39. The method of claim 29, wherein the thermally stable adhesive substantially maintains the thermal conductivity of the susceptor at a temperature of about 250° F. (121° C.) and above.

40. The method of claim 29, wherein the thermally stable adhesive substantially maintains portions of the susceptor adjacent one or more discontinuities extending through the susceptor in at least partial contact at a temperature of about 250° F. (121° C.) and above.

41. The method of claim 40, wherein the thermally stable adhesive provides a binding force to portions of the susceptor adjacent the one or more discontinuities.
